(19) United States
(12) Patent Application Publication
(10) Pub. No.: US 2025/0260220 A1
(43) Pub. Date: Aug. 14, 2025

(54) HANDLING CABLES IN OFFSHORE INSTALLATIONS

(71) Applicant: ACERGY FRANCE SAS, Suresnes (FR)

(72) Inventors: Hong Duc PHAM, Suresnes (FR); Lars FROYD, Drammen (NO); Charles Marc Antoine DONNET, Saint Maurice (FR); Mathurin Michel Pierre LEGRAND, Paris (FR); Sonia GIRAUDBIT, Montigny-le-Breton (FR); Pierre REBOUL, Suresnes (FR); Bastien LE-DREFF, Suresnes (FR); Armand BAUDART, Boulogne Billancourt (FR)

(21) Appl. No.: 18/857,961

(22) PCT Filed: Apr. 21, 2023
(86) PCT No.: PCT/IB2023/000208

§ 371 Date: Oct. 18, 2024

(30) Foreign Application Priority Data
Apr. 21, 2022 (GB) 2205831.7
Nov. 30, 2022 (GB) 2218036.8

(51) Int. Cl. H02G 9/12

(52) U.S. Cl. CPC H02G 9/12

(57) ABSTRACT

A floating cable connection for an offshore structure such as a floating wind turbine comprises two or more substantially parallel elongate tubes each comprising an internal passageway for accommodating a respective cable. At least one buoyant element is fixed to the tubes and support formations fixed relative to the or each buoyant element are arranged to hold the tubes in an upright orientation on the offshore structure. The buoyant element comprises a hollow housing containing at least one electrical connector such as a junction box within a watertight internal compartment. The or each connector electrically connects upper ends of the cables to each other.

This invention relates to techniques for handling cables used with offshore installations such as wind turbines, especially floating wind turbines or other installations that are moored to float at the surface of the sea.

The invention aims to simplify the installation, maintenance and decommissioning of offshore structures. The invention does so by addressing challenges of handling electrical connections to and between such structures via cables that, for example, convey electrical power from wind turbines or other electricity generators. In particular, the invention is concerned with connecting cables to such structures and disconnecting cables from such structures when at sea.

Offshore wind turbines will be used in this specification to exemplify the invention, although the invention could be used with other offshore installations requiring electrical connection between discrete structures, such as electrical substations, tidal energy systems, water turbines or other generators. For example, access to a floating wind turbine may be required to disconnect cables that connect the turbine to other turbines or to a substation hub of an offshore wind farm. Disconnecting such interconnecting cables from a turbine or other unit isolates the unit electrically and allows the unit to be moved if required.

Access to offshore wind turbines for installation, maintenance and decommissioning is often hampered by bad weather and especially by high seas. Such conditions present a risk to personnel and equipment; they also make it difficult to dock a maintenance vessel to a turbine structure and to perform precise lifting and positioning operations. While waiting for a weather window, expensive vessels could lie dormant and essential maintenance could be delayed for days or even weeks.

The challenges of bad weather affect all offshore installations from time to time but especially floating wind turbines. Floating wind turbines tend to lie in deeper water and to be located further offshore than fixed wind turbines, hence being more exposed to high seas. Also, unlike fixed wind turbines, floating wind turbines may not allow cables and electrical systems to be accessed easily from a tower, a jacket or a platform.

EP 2732516 and GB 2586799 disclose offshore installations in which cables between discrete units of those installations, and connectors forming part of those cables, remain on the seabed during normal operations but can be recovered to the surface for maintenance. Their location on the seabed requires the connectors to be designed for leak-tightness over long periods underwater and makes disconnection time-consuming because the cables must firstly be located on the seabed and then must be lifted to the surface. It is simpler, and therefore preferred, to mount a cable connector on a wind turbine at a location at or above the surface, where the connector is more accessible and does not have to handle significant hydrostatic pressure in normal use.

If a connector is designed for use at or above the surface, it is undesirable to allow the connector to sink to the seabed with the remainder of a cable when the cable is disconnected from an offshore structure. Consequently, there have been proposals in the prior art for floating connectors that remain at the surface. There, the connector is subjected to no more than minimal hydrostatic pressure and is easy to locate and recover for eventual reconnection to an offshore structure if desired.

In EP 3212496 and EP 3566941, a floating connector comprises a long spar-like floating I-tube within which submarine cables extend to connect to an offshore energy device. The floating connector disclosed in WO 2022/040634 is based on a similar principle. However, in each case, the use of an internal air-filled compartment as the main buoyancy provision renders the connector subject to accidental flooding, hence risking the connector sinking to the seabed in the event of leakage. Also, the cable arrangement makes it difficult to maintain electrical isolation of, and between, cables operating at high voltage.

WO 2021/001118 discloses a maritime cable float comprising an on-board sensor disposed to sense a measurement value dependent on the floating depth of the float and a communication device that is operable to transmit information on the measured value detected by the sensor. It is noted that although the cable float disclosed provides buoyancy to a cable, it does not float at the sea surface and therefore prevents simple retrieval, both through locating the cable and retrieving it from beneath the sea surface.

Against this background, the invention resides in a floating cable connection that comprises: two or more substantially parallel elongate tubes each comprising an internal passageway for accommodating a respective cable; at least one buoyant element fixed to the tubes; and support formations fixed relative to the or each buoyant element, arranged to hold the tubes in an upright orientation on a supporting structure.

The buoyant element may, for example, comprise a hollow housing containing at least one electrical connector such as a junction box within a watertight internal compartment, the or each connector electrically connecting upper ends of the cables to each other. The passageways of the tubes suitably communicate with the internal compartment. The buoyant element may further comprise buoyancy mounted externally to the housing.

An access opening may be provided in a wall of the housing, for example an upper wall of the housing, communicating with the internal compartment to provide access to the at least one electrical connector. A closure may close the access opening.

The housing may, for example, be cylindrical or crescent-shaped. Where the housing is crescent-shaped, downwardly-extending legs of the crescent shape may communicate with the passageways of the tubes.

The connection could further comprise at least one anchor line or mooring line extending from the housing to a subsea foundation. Such an anchor line or mooring line may conveniently be coupled to the housing at a location between the tubes. Cables can hang from the respective tubes to the seabed in catenary, wave or S configurations.

The support formations may comprise at least one support protruding laterally from each tube, such as a flange that lies in a plane intersected by the or each tube.

Where the tubes are mutually spaced along their length, the or each buoyant element can bridge a horizontal gap between the tubes.

At least one of the tubes may have a lower end portion that is inclined relative to a longitudinal axis of an upper end portion of that tube. More generally, lower end portions of the tubes could be downwardly divergent from each other.

Each tube may be, or may comprise, a bend stiffener. In that case, a bend stiffener could extend from a lower end of each tube, and at least one of the bend stiffeners could be inclined relative to a longitudinal axis of the tube. For example, the bend stiffeners could be downwardly divergent from each other. Alternatively, the bend stiffener could extend longitudinally in coaxial alignment with a longitudinal axis of the tube.

In some embodiments, the connection comprises three of the substantially parallel elongate tubes all fixed to a common buoyant element, the tubes being in a triangular array in plan view.

The inventive concept embraces an offshore structure, such as a wind turbine, in combination with at least one connection of the invention. The connection may be electrically connected to the structure, for example through the access opening of the housing.

The structure may have support formations that are complementary to the support formations of the or each connection. For example, the support formations of the structure may be arranged for hang-off engagement with the support formations of the or each connection.

The inventive concept also encompasses a corresponding method of disconnecting at least two cables from an offshore structure. The method comprises: holding upper end portions of the cables within respective upright elongate tubes fixed relative to each other and removably supported by the structure; disconnecting upper ends of the cables from an electrical system of the structure; electrically connecting the upper ends of the cables to each other; detaching the tubes containing the upper end portion of the cables from the structure; transferring the tubes containing the upper end portions of the cables into water beside the structure; and supporting the tubes and the upper end portions of the cables in the water by virtue of at least one buoyant element fixed to the tubes.

The upper ends of the cables may be electrically connected to each other within an internal watertight compartment of the buoyant element. For that purpose, the method may comprise opening an access opening in a wall of the buoyant element, accessing the compartment through the access opening, electrically connecting the upper ends of the cables to each other, and closing the access opening.

Exemplary embodiments of the invention provide an electrical junction for cables extending from or to a floating wind turbine, the junction comprising: a substantially horizontally extending housing, comprising at least one watertight opening, such as a hatch that could be located on the top of the housing, and at least two vertical passageways for cables; an electrical junction box inside the housing, accessible through the opening when it is open; bend stiffeners in watertight connection to the passageways of the housing and surrounding the cables running through the passageways; and a detachable mechanical connection to the wind turbine.

The housing may have a cylindrical shape or a crescent shape that is cylindrical globally or overall, the passageways suitably being in horns of the crescent in that case.

The electrical junction box may connect at least two cables together inside the housing and may connect the cables to the electrical system of the wind turbine through the opening in the housing.

The junction can float in water when detached from the wind turbine thanks to air trapped inside the housing and/or additional buoyancy such as foam.

The junction may further comprise an anchoring line connected to an anchor on the seabed. More generally, the junction may comprise an anchor system comprising a mooring line and a dead-man anchor or clump weight. The anchor system may be permanent or detachable.

The connection between the housing and the bend stiffeners may be or may comprise a flange. Such flanges can also serve as a detachable mechanical connection to a hang-off structure of the floating wind turbine.

The invention also resides in a floating cable connection that comprises: at least one elongate rigid tube defining an internal passageway for accommodating a cable; at least one buoyancy element external to, and fixed relative to, the or each tube; and support formations fixed relative to the or each tube, arranged to hold the or each tube in an upright orientation on a supporting structure. The or each tube need not be sealed and could, for example, be open-ended.

The support formations may comprise at least one support. Supports may be spaced apart longitudinally along one or more tubes at upper and lower positions, in which case buoyancy elements may conveniently be disposed longitudinally between the upper and lower supports. More generally, a stack of discrete buoyancy elements can extend along the or each tube.

A buoyancy element used in the invention preferably comprises a solid body of material, such as a foam comprising a polymeric matrix, whose specific density is lower than that of seawater. Such a buoyancy element may be attached to a tube or housing and/or may surround a tube or housing.

There may be two or more substantially parallel tubes, which may be mutually spaced along their length. One or more of the aforementioned supports conveniently bridge the gap between the tubes. The tubes may be disposed together within a shared tubular housing, in which case a buoyancy element may conveniently be attached to or surround the housing. Alternatively, each tube may have a respective discrete buoyancy element mounted on or around it.

Where a cable is received within a tube, the cable preferably extends along a full length or most of the length of the surrounding tube and protrudes from a lower end of that tube, for example through a bend stiffener. The cable may also protrude from an upper end of the tube or through a side of the tube.

The inventive concept also extends to a corresponding method of disconnecting a cable from an offshore structure. The method comprises: holding an upper end portion of the cable within an upright elongate tube removably supported by the structure; disconnecting an upper end of the cable from an electrical system of the structure; detaching the tube containing the upper end portion of the cable from the structure; transferring the tube containing the upper end portion of the cable into water beside the structure; and supporting the tube and the upper end portion of the cable at the surface of the water by virtue of buoyancy disposed externally with respect to the tube.

Upper end portions of at least two cables may be held in respective tubes fixed relative to each other. After disconnecting the upper ends of the cables from the electrical system of the structure, the upper ends of the cables may be connected electrically to each other.

A protective cap may be fixed to an upper end of a tube, over the upper end of a cable, after disconnecting the upper end of the cable from the electrical system of the structure.

In summary, the invention may employ the principle of splitting a connector for uncoupling and recovering electrical cables used in offshore installations.

Embodiments of the invention comprise a floating cable connection for an offshore wind turbine such as a floating wind turbine, the connection comprising: at least one tube providing a passage for at least one cable, the tube being capable of being coupled to or decoupled from the wind turbine; and an external buoyancy element on or around the tube, for example at least one external buoyancy ring around the tube. A buoyancy ring may comprise two or more ring elements. Buoyancy elements may comprise a polymeric foam material, such as a syntactic foam.

The connection may comprise at least two tubes that are mechanically connected together by members in a bracing arrangement. The or each tube may have an I- or J-shape and may be integral with a bend stiffener.

The or each tube may have an individual buoyancy element, for example being surrounded by an individual buoyancy ring, or two or more tubes may share a buoyancy element, for example being disposed within a shared buoyancy ring. One or more of the tubes may be inserted into and secured inside a carrier tube or other housing. In that case, one or more buoyancy elements can be located on the carrier tube. For example, a buoyancy ring can be located around the carrier tube.

The or each tube may have an open top and therefore can be unsealed, hence not necessarily being watertight or airtight. Electrical connection of the or each cable, such as a junction, a connector or a splice, may be located or effected at the top of the or each tube. Side entry of the cables through a lateral opening of the or each tube is a possible alternative, such lateral opening preferably also being located at or near the top of the or each tube.

The connection may float independently in the sea or may be attached to or suspended from a float or other structure of a floating wind turbine. The connection may be moored to the seabed or to the floating wind turbine. When attached to a floating wind turbine, the connection may be mounted to a side of the float or may be mounted in a well or other recess of the structure of the float. The connection may comprise a mount such as a hang-off extension to be laid on a hang-off receptacle of the float.

In another expression of the invention, a floating cable connection comprises: at least one elongate rigid tube defining an internal passageway for accommodating a cable; at least one buoyancy element external to, and fixed relative to, the or each tube; and support formations fixed relative to the or each tube, arranged to hold the or each tube in an upright orientation on a supporting structure. The or each tube need not be sealed and could, for example, be open-ended.

The support formations may comprise at least one support protruding laterally from the or each tube. For example, a support may be a plate that lies in a plane intersected by a tube. Supports may be spaced apart longitudinally along one or more tubes at upper and lower positions, in which case buoyancy elements may conveniently be disposed longitudinally between the upper and lower supports. More generally, a stack of discrete buoyancy elements can extend along the or each tube.

A buoyancy element used in the invention preferably comprises a solid body of material, such as a foam comprising a polymeric matrix, whose specific density is lower than that of seawater. Such a buoyancy element may be attached to a tube and/or may surround a tube.

There may be two or more substantially parallel tubes, which may be mutually spaced along their length. One or more of the aforementioned supports conveniently bridge the gap between the tubes. The tubes may be disposed together within a shared tubular housing, in which case a buoyancy element may conveniently be attached to or surround the housing. Alternatively, each tube may have a respective discrete buoyancy element mounted on or around it.

A connection of this example may comprise at least one tube having a lower end portion inclined relative to a longitudinal axis of an upper end portion of that tube. Thus, the connection can comprise two or more tubes whose lower end portions are downwardly divergent from each other.

A bend stiffener preferably extends from a lower end of each tube. The bend stiffener may be inclined relative to a longitudinal axis of the otherwise substantially straight tube or may extend longitudinally in coaxial alignment with that axis. Where there are two or more tubes each with an inclined bend stiffener, those bend stiffeners can point in substantially the same direction or can instead be downwardly divergent.

Where a cable is received within a tube, the cable preferably extends along a full length or most of the length of the surrounding tube and protrudes from a lower end of that tube, for example through a bend stiffener. The cable may also protrude from an upper end of the tube or through a side of the tube.

This expression of the inventive concept embraces a combination of at least one connection of the invention with an offshore structure such as a floating wind turbine. The structure may have support formations that are complementary to the support formations of the connection. For example, the support formations of the structure may be arranged for hang-off engagement with the support formations of the connection.

This expression of the inventive concept also extends to a corresponding method of disconnecting a cable from an offshore structure. The method comprises: holding an upper end portion of the cable within an upright elongate tube removably supported by the structure; disconnecting an upper end of the cable from an electrical system of the structure; detaching the tube containing the upper end portion of the cable from the structure; transferring the tube containing the upper end portion of the cable into water beside the structure; and supporting the tube and the upper end portion of the cable at the surface of the water by virtue of buoyancy disposed externally with respect to the tube.

Upper end portions of at least two cables may be held in respective tubes fixed relative to each other. After disconnecting the upper ends of the cables from the electrical system of the structure, the upper ends of the cables may be connected electrically to each other.

A protective cap may be fixed to an upper end of a tube, over the upper end of a cable, after disconnecting the upper end of the cable from the electrical system of the structure.

In summary, a floating cable connection of the invention for an offshore structure such as a floating wind turbine comprises two or more substantially parallel elongate tubes each comprising an internal passageway for accommodating a respective cable. At least one buoyant element is fixed to the tubes and support formations fixed relative to the or each buoyant element are arranged to hold the tubes in an upright orientation on the offshore structure. The buoyant element comprises a hollow housing containing at least one electrical connector such as a junction box within a watertight internal compartment. The or each connector electrically connects upper ends of the cables to each other.

A floating cable connection of the invention also comprises elongate rigid tubes, each defining an internal passageway that accommodates a respective cable. Support formations hold the tubes in an upright orientation on an offshore structure such as a floating wind turbine but allow the tubes to be lifted from the structure and into the surrounding water. Buoyancy elements external to the tubes generate enough buoyant upthrust to support the connection and the upper end portions of the cables at the surface of a body of water, with other portions of the cables suspended beneath the floating connection.

In order that the invention may be more readily understood, reference will now be made, by way of example, to the accompanying drawings in which:

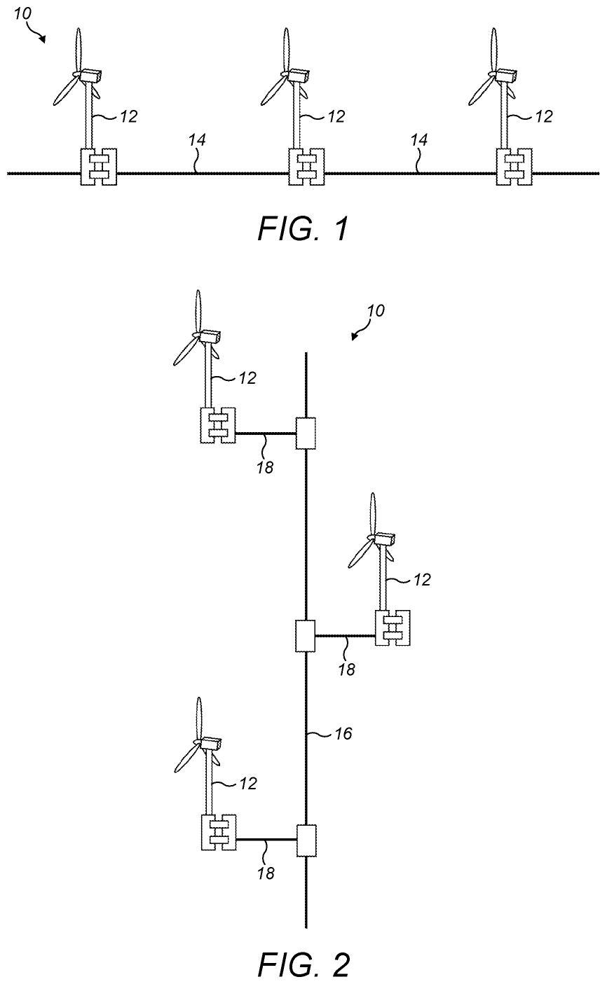

FIG. 1 is a schematic diagram of a group of offshore wind turbines electrically connected in series;

FIG. 2 is a schematic diagram of a group of offshore wind turbines electrically connected in parallel;

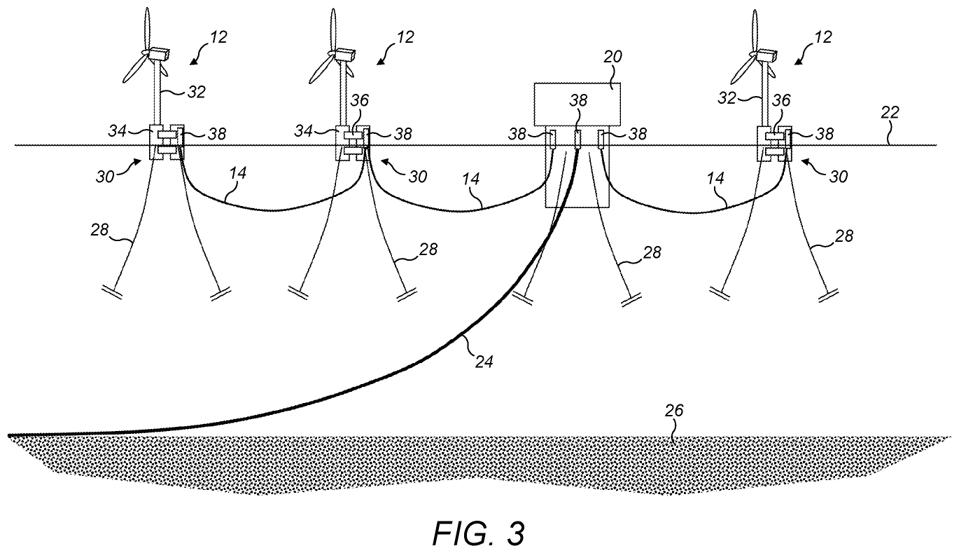

FIG. 3 is a schematic side view of a group of offshore wind turbines electrically connected in series to each other and to a substation hub, showing mooring arrangements of the various units and an export cable extending from the hub;

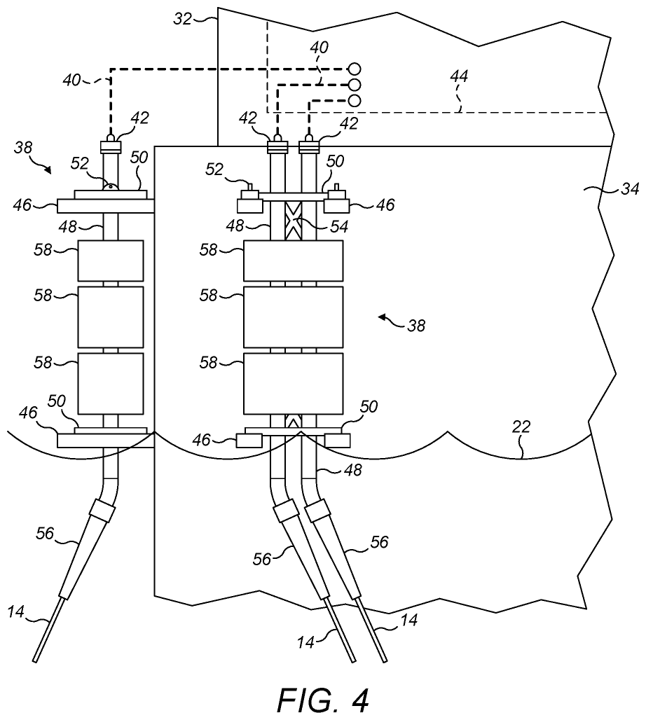

FIG. 4 is a side view of a wind turbine float fitted with cable connections of the invention;

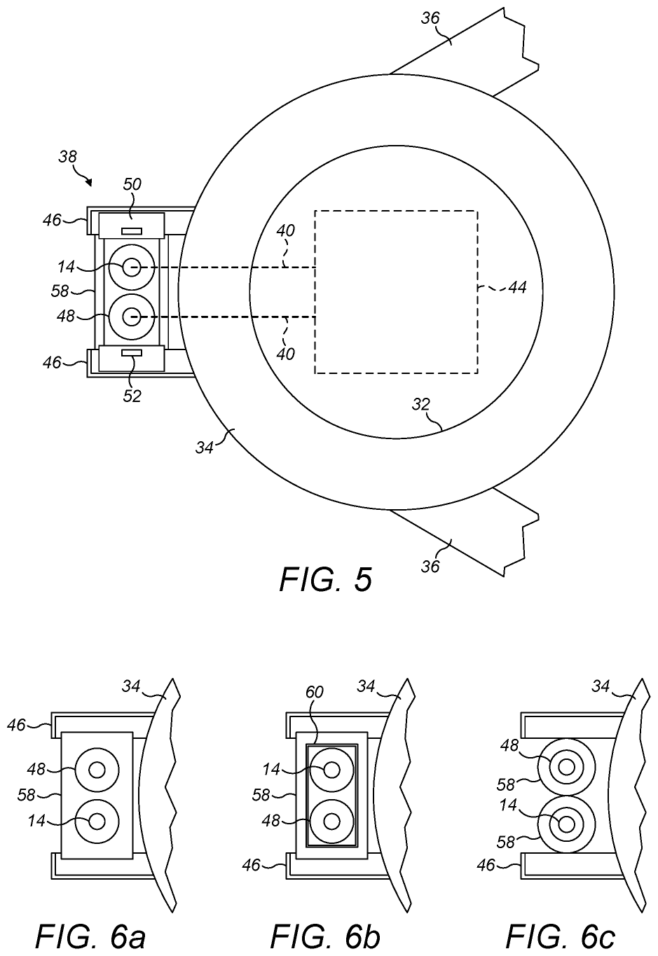

FIG. 5 is a plan view of the float of FIG. 4, showing one of the cable connections;

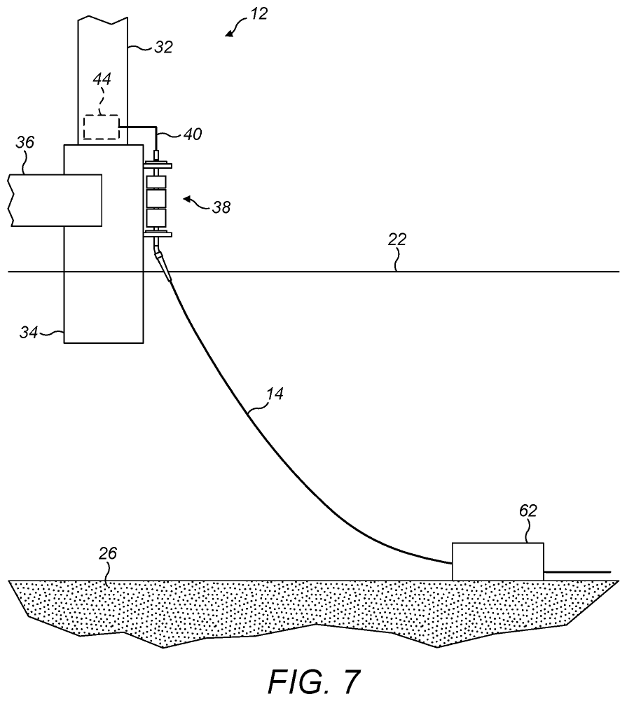

FIGS. 6a, 6b and 6c are schematic views showing variants of a detail of FIG. 5 in horizontal section;

FIG. 7 is a schematic side view of a wind turbine fitted with a cable connection of the invention, connected in this instance to a connector module on the seabed;

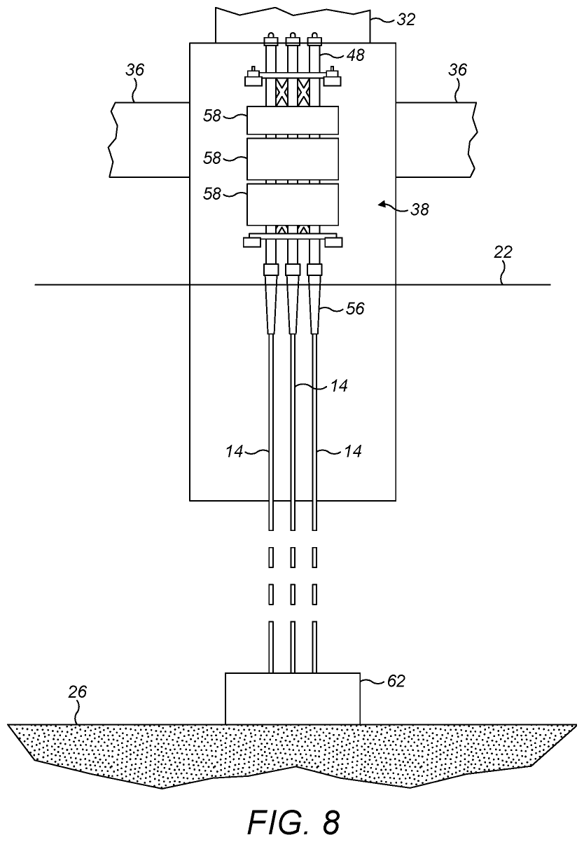

FIG. 8 is a schematic side view of another cable connection of the invention, again shown here connected to a connector module on the seabed;

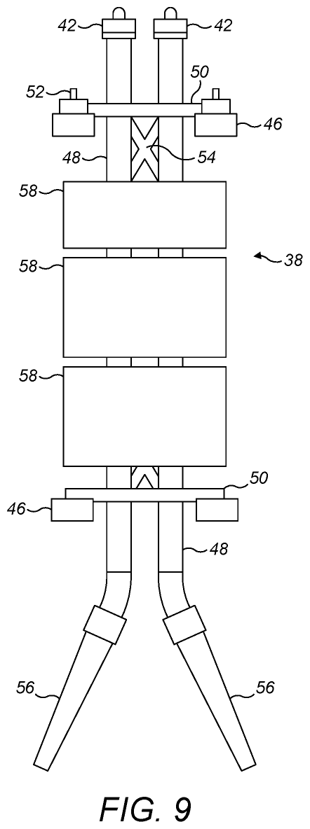

FIG. 9 is a schematic side view of another cable connection of the invention;

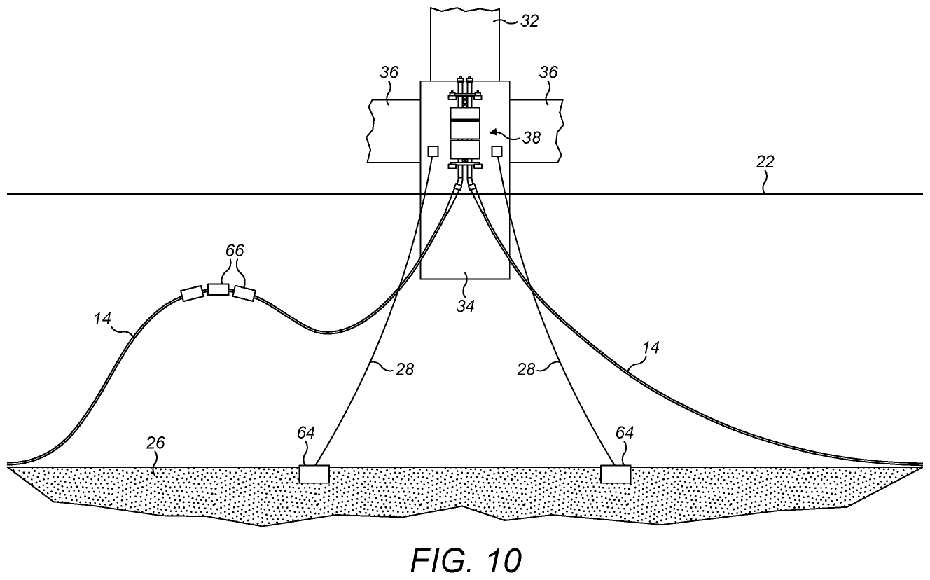

FIG. 10 is a schematic side view of a wind turbine float fitted with the cable connection of FIG. 9;

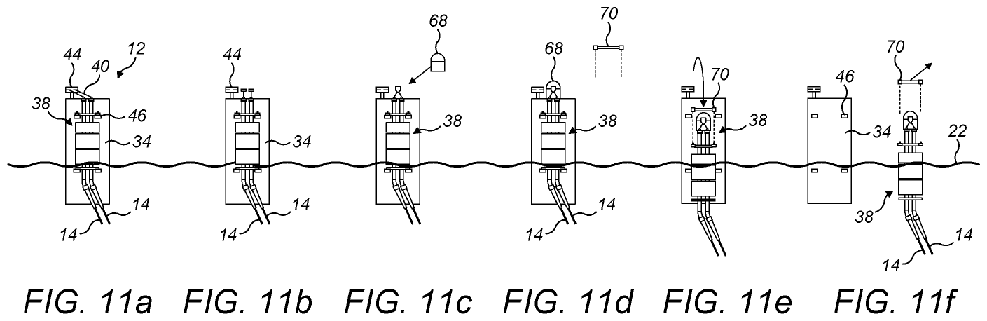

FIGS. 11e to 11f are a sequence of schematic side views showing a connection of the invention being disconnected from a wind turbine float;

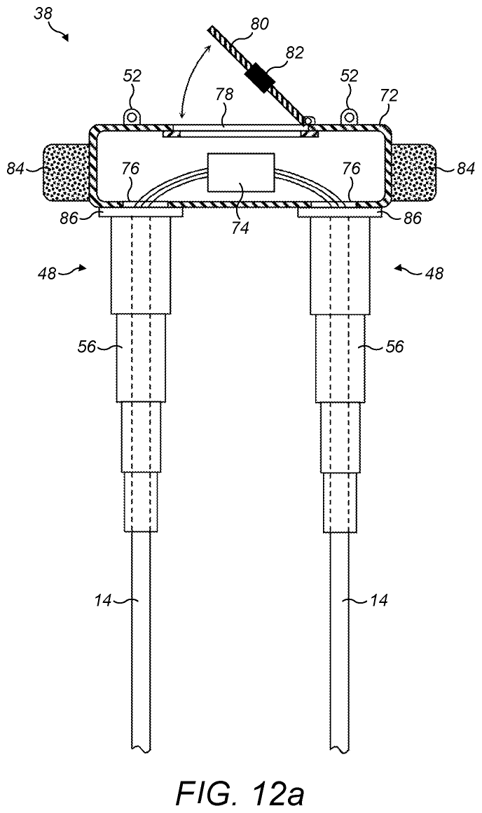

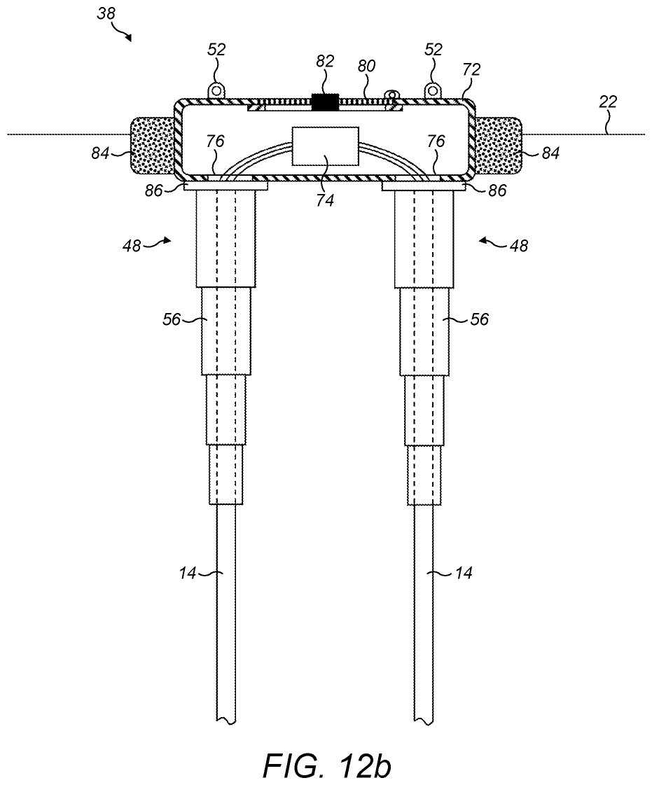

FIGS. 12a and 12b are schematic sectional side views of a cable connection of the invention, comprising a hollow housing that contains a junction box;

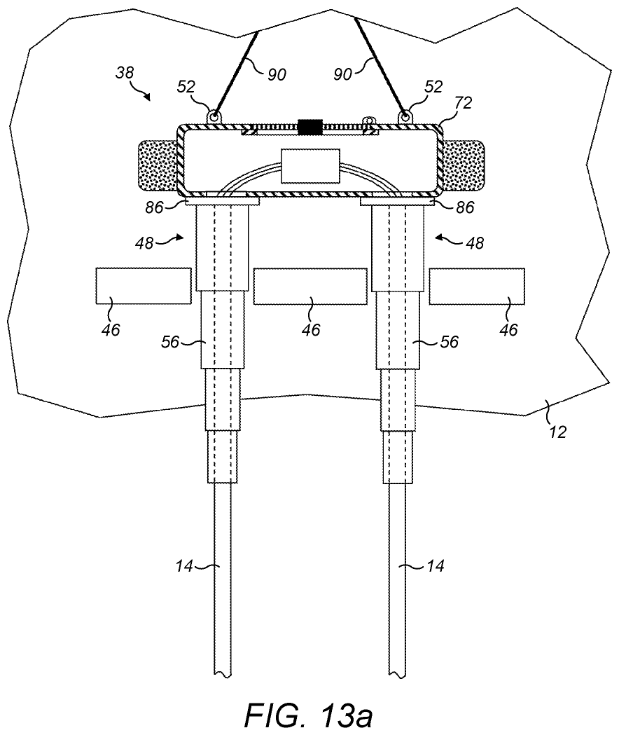

FIGS. 13a and 13b show the cable connection of FIGS. 12a and 12b being hung off a supporting structure such as a wind turbine float;

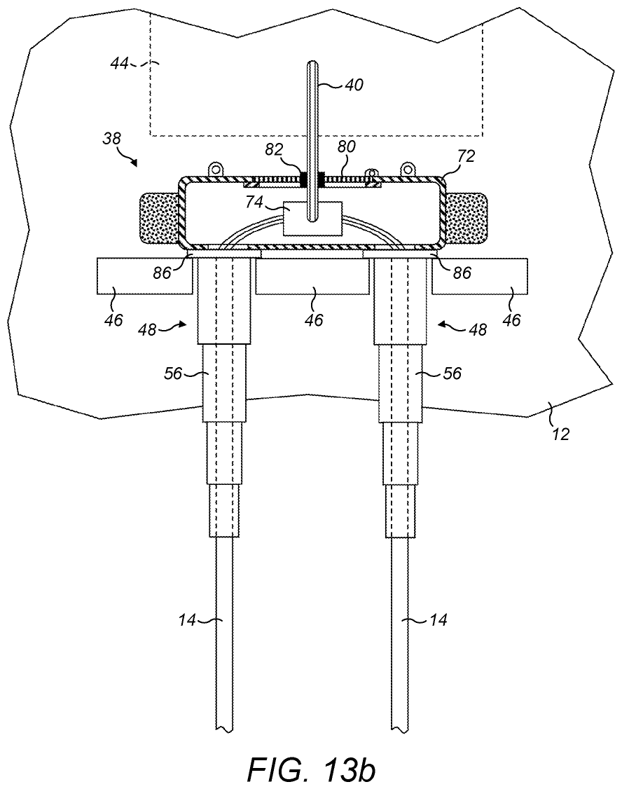

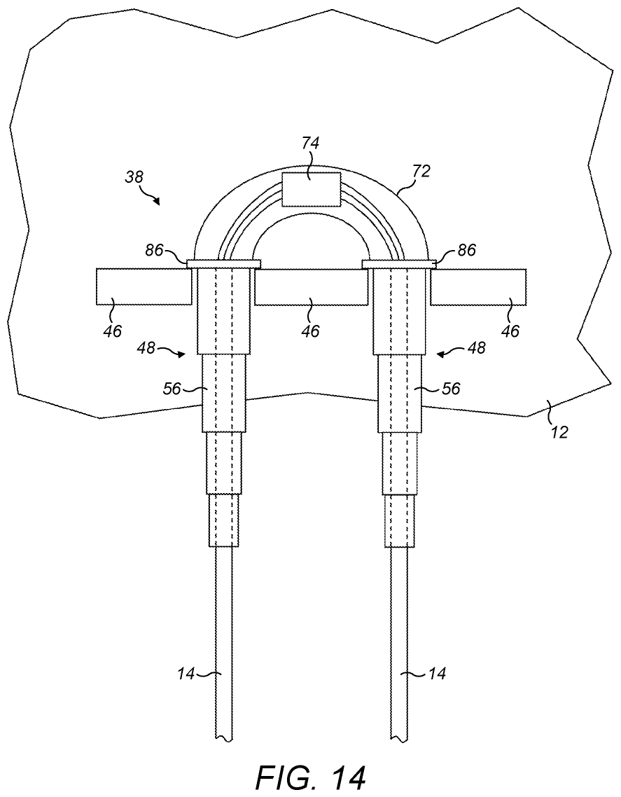

FIG. 14 corresponds to FIG. 13b but shows a different configuration of the housing;

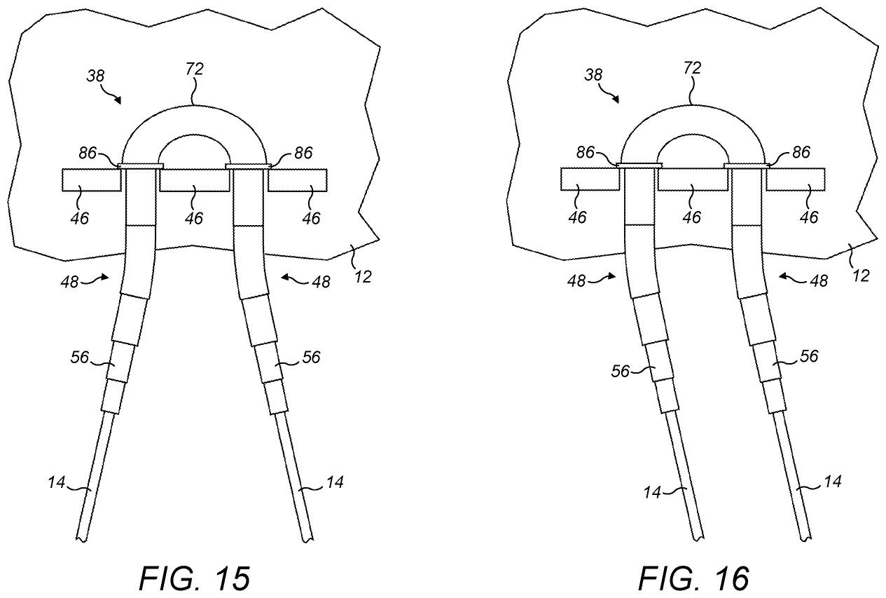

FIGS. 15 and 16 correspond to FIG. 14 but show bend stiffeners inclined to the vertical;

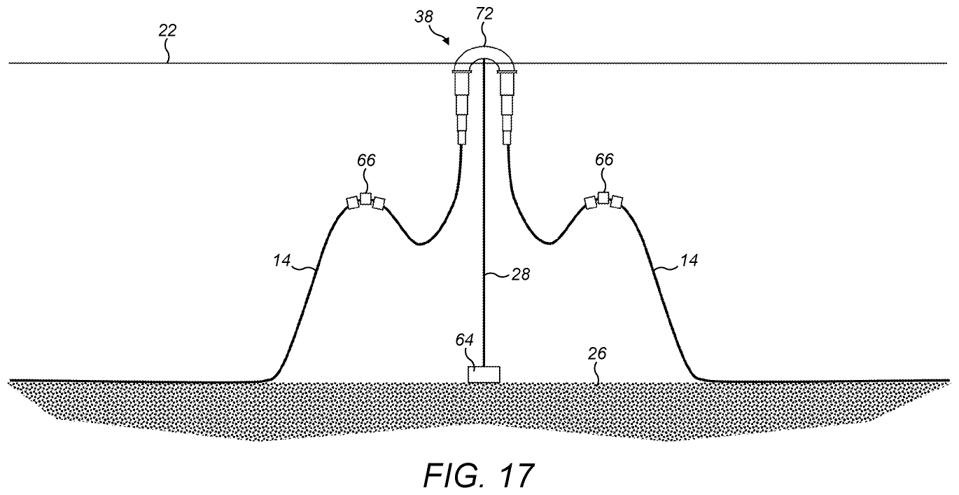

FIG. 17 is a schematic side view of a mooring system for the cable connection of FIG. 14, shown when floating in water;

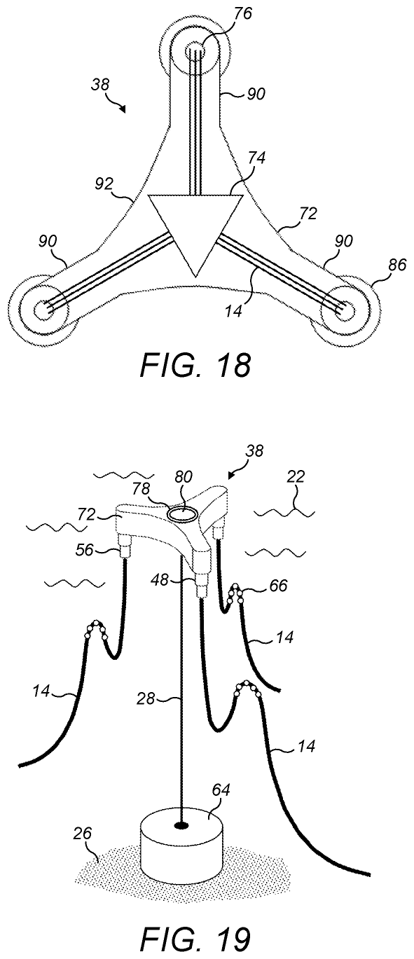

FIG. 18 is a schematic sectional plan view of a cable connection of the invention for effecting connections between more than two cables; and

FIG. 19 is a perspective view of a mooring system for the cable connection of FIG. 18, shown when floating in water.

Referring firstly to FIGS. 1 and 2, these diagrams show series and parallel arrangements for electrical interconnection within groups 10 of floating wind turbines 12. Connections of the invention may be used in both arrangements. In the group 10 shown in FIG. 1, the turbines 12 are connected in series by cables 14 in a daisy-chain arrangement. Conversely, the group 10 of FIG. 2 shows the turbines 12 connected in parallel. In that case, each turbine 12 is connected to a spine conductor 16 by a respective spur 18 that may comprise two or more cables.

FIG. 3 further exemplifies the invention by showing turbines 12 connected in series, that series also including a substation hub 20 that gathers electrical energy directly or indirectly from each turbine 12. An export cable 24 hangs as a catenary from the hub 20 to the seabed 26 to transfer the electrical energy to a consumer. In this example, the turbines 12 and the hub 20 all float at the surface 22, kept on station by respective sets of moorings 24.

Each turbine 12 comprises a buoyant base 30 surmounted by a mast or tower 32. The base 30 of each turbine 12 is exemplified here as being of a conventional semi-submersible type, comprising a triangular arrangement of three buoyant columns or floats 34 joined by horizontal struts 36.

In this example, the cables 14 that connect the turbines 12 to each other and to the hub 20 each hang in the water column as catenaries. Each cable 14 terminates at both ends in a connection 38 of the invention, shown here side-mounted on a float 32 of each turbine 12 and on the hub 20. In this example, the hub 20 includes a further connection 38 that supports the upper end of the export cable 24. It will be noted that the connection 38 of at least one of the turbines 12 supports two cables 14, thus providing for onward connection to the next turbine 12.

Turning next to FIG. 4, this shows a float 34 of a turbine 12 supporting two connections 38 of the invention. FIG. 5 is a plan view showing one of the connections 38 shown in FIG. 4. Each connection 38 serves as a carrier that surrounds and supports an upper end portion of one or more catenary cables 14.

Intermediate cables 40 extend from the connection 38 to the turbine 12. Each intermediate cable 40 is joined to the top of a respective cable 14 by a releasable coupling 42 to effect connection between that cable 14 and a junction box 44 of the turbine 12, shown here housed within the tower 32.

In this example, each connection 38 is supported by hang-off formations protruding horizontally from a vertically-extending side wall of the float 34. The hang-off formations comprise upper and lower pairs of supports 46 in mutual vertical alignment. The supports 46 of each pair are spaced apart from each other to define a vertically-extending channel between them that accommodates the connection 38.

Each connection 38 comprises at least one rigid vertically-extending tube 48 that surrounds and accommodates the upper end portion of the or each cable 14 terminated by that connection 38. The tube 48 is surmounted by a respective coupling 42. Where a connection 38 supports two or more cables 14 as shown in FIGS. 4 and 5, there is a corresponding number of tubes 48 in an array extending parallel to and spaced laterally from each other. The tube 48 may be an ‘I-tube’, with a straight shape, or a ‘J-tube’ that comprises an inclined or bent bottom section.

By enclosing adjacent cables 14 and maintaining a gap between them, the tubes 48 protect the cables 14, control the paths of the cables 14 to prevent inadvertent contact and ensure effective electrical isolation between the cables 14.

Hang-off formations of each connection 38, exemplified here by vertically-spaced plates 50, extend horizontally across and protrude laterally from the connection 38. The protruding ends of the plates 50 lie on and engage respective supports 46 of the complementary hang-off formations on the float 34. The protruding ends of the upper plate 50 have lifting formations, such as padeyes 52, that facilitate lifting the connection 38 from the supports 46 with the cables 14 suspended beneath.

The plates 50 are fixed relative to the or each tube 48. Where there are two or more tubes 48, each plate 50 bridges the horizontal gaps between the tubes 48 to connect the tubes 48 as a rigid structure. The tubes 48 may additionally, or alternatively, be connected by bracing 54 for the same purpose.

At its lower end, each tube 48 terminates in a bend stiffener 56 that tapers downwardly around a respective cable 14 hanging from the connection 38. In this example, each bend stiffener 56 is inclined relative to the vertical axis of the associated tube 48. Consequently, the tubes 48 shown here are J-tubes, a configuration preferred to suit the orientation of the upper portion of a catenary-curved cable 14. Here, the distal end of each bend stiffener 56 points laterally, across or around the face of the float 34, and outwardly, away from the face of the float 34.

Where a connection 38 comprises two or more tubes 48, the bend stiffeners 56 of those tubes 48 may be oriented to point in substantially the same direction, for example substantially parallel to each other as shown. Other arrangements, to be described later with reference to FIGS. 8 and 9, comprise I-tubes in which a bend stiffener 56 is in parallel or coaxial alignment with the associated tube 48 and J-tubes in which the bend stiffeners 56 of adjacent tubes 48 diverge downwardly.

As indicated by the level of the water surface 22 shown in FIG. 4, at least a lower end of a connection 38 could be submerged or exposed to the splash zone arising from wave action. However, this does not expose the connection 38 to long-term deep submergence or to significant hydrostatic pressure, and therefore allows the connection 38 to be simpler than subsea connectors known in the prior art.

When lifted from the supports 46 using the padeyes 52, the connection 38 can be lowered into the sea to float independently from the wind turbine 12. For this purpose, the connection 38 further comprises one or more buoyancy elements 58 that are external to the tubes 48, for example surrounding the tubes 48 as shown. Each buoyancy element 58 is a solid body of foam material, for example a syntactic foam, that is positively buoyant in seawater. The density and aggregate displacement of the buoyancy elements 58 confers positive buoyancy on the connection 38 that is sufficient to support the weight of the connection 38 and of the cables 14 suspended beneath it, as will be explained.

The or each buoyancy element 58 is fixed to the tubes 48 and/or to a structure supporting the tubes 48, such as the aforementioned bracing 54. Where there are two or more tubes 48, a buoyancy element 58 bridging the gaps between those tubes 48 can contribute to the structural integrity of the assembly.

Two or more buoyancy elements 58, in this example three such elements, may be stacked vertically along the tubes 48 as shown. This modular approach to buoyancy makes it simple to tailor buoyancy to the suspended weight of the cables 14 and to adjust the trim of the connection 38, when the connection 38 is removed from the wind turbine 12 and floats independently in the surrounding water.

In the examples shown in FIGS. 4 and 5, the buoyancy elements 58 extend between, and are shared between, more than one tube 48 of a connection 38. For example, the buoyancy elements 58 can encircle or embed the tubes 48 in direct contact with the tubes 48 as shown in FIG. 6a or may be disposed outside a carrier tube 60 that houses the tubes 48 as shown in FIG. 6b. Alternatively, a buoyancy element 58 on one tube 48 could be separate from a buoyancy element 58 on another tube 48 as shown in FIG. 6c.

In example shown in FIG. 3, the cables 14 that connect the turbines 12 to each other and to the hub 20 each hang in the water column as catenaries. Alternatively, the central portion of any of those cables 14 could instead lie on the seabed 26. For example, FIG. 7 shows an arrangement in which a cable 14 hangs as a catenary between a connection 38 on a turbine 12 and the seabed 26. Optionally, as in this example, the cable connects to a junction box 62 on the seabed 26.

FIG. 8 shows the possibility of more than two cables 14 per connection 38, in this case three cables 14 that are shown here hanging substantially in parallel between a connection 38 and a junction box 62 on the seabed 26. The upper end portion of each cable 14 is housed in its own respective tube 48 of the connection 38. In this case, the tubes 48 are I-tubes, meaning that their bend stiffeners 56 are in parallel or coaxial alignment with the respective tubes 48. Thus, the cables 14 hang initially in a substantially vertical orientation beneath the bend stiffeners 56.

FIG. 9 shows a variant in which at least two tubes 48 of a connection 38 have downwardly-divergent bend stiffeners. This suits a series connection between floating units like that shown in the example of FIG. 3, where catenary cables 14 splay apart from such a unit in different directions. A further example of this is shown in FIG. 10, where the connection 38 of FIG. 9 is shown on a float 34 of a wind turbine, moored to subsea foundations 64 by mooring lines 28. The cable 14 shown on the left in FIG. 10 is in a wave configuration, supported by buoyancy units 66 that form a hogbend, whereas the cable 14 shown on the right in FIG. 10 is in a conventional catenary configuration.

FIGS. 11a to 11f are a sequence of views that show how a connection 38 of the invention can be decoupled from a floating unit such as a wind turbine 12 and then lowered into the sea to float independently. This allows the floating unit to be moved or removed for maintenance or replacement, or to reconfigure an offshore installation.

FIG. 11a shows a pair of cables 14 supported by a connection 38 like that shown in FIG. 4. The connection 38 is supported, in turn, by hang-off supports 46 on the turbine float 34, with intermediate cables 40 effecting electrical connection between the cables 14 and a junction box 44 of the turbine 12.

In FIG. 11b, the intermediate cables 40 have been removed or disconnected to sever the electrical connection between the cables 14 and the junction box 44. This leaves the upper ends of the cables 14 exposed.

In FIG. 11c, the exposed upper ends of the cables 14 have been spliced or otherwise connected together to connect the cables 14 in series, thus restoring the circuit that was previously routed through the junction box 44. FIG. 11c also shows a protective cap 68 that is then shown in FIG. 11d fitted over the spliced upper ends of the cables 14. Individual caps 68 could be fitted over the upper end of each cable 14 if the cables 14 are not spliced together.

FIG. 11d also shows lifting gear 70 that can be coupled to the padeyes 52 of the connection 38 as shown in FIG. 11e. FIG. 11e then shows the lifting gear 70 used to lift the connection 38 from the hang-off structure and to lower the connection 38 to the surface 22 of the sea.

FIG. 11f shows the connection 38 released from the lifting gear 70 and left to float in the sea, independently of the turbine float 34. The wind turbine 12 can now be towed away or maintained while the floating connection 38 maintains the electrical integrity of the installation.

When at the surface 22, the floating connection 38 is not exposed to significant hydrostatic pressure and therefore can protect the cables 14 without requiring robust sealing or other complexity. When it is desired to couple the floating connection 38 to a wind turbine 12 again, it is simple to locate and recover the connection 38 from the surface 22 and to lift the connection 38 back into engagement with hang-off supports 46 of a turbine float 34.

To limit its area of excursion when floating, the connection 38 can be moored to the seabed 26 or to another structure such as a wind turbine 12. In any event, excursion of the floating connection 38 will be limited if a cable 14 suspended from the connection 38 lies on the seabed 26 or is connected to a junction box 62 at the seabed 26 as shown in FIG. 7, 8 or 10.

Turning next to FIGS. 12a to 13b, these drawings show another embodiment of the invention for handles cables disconnected from and reconnected to a floating wind turbine. In this embodiment, two cables 14 hang from a floating connection 38 that comprises a hollow housing 72. The housing 72 defines an internal watertight compartment containing an electrical junction box 74 that lies between upper ends of the cables 14 and connects the upper ends of the cables 14 to each other. The housing 72 may, for example, have a cylindrical, cuboidal or other horizontally-extending shape. The cables 14 enter the housing 72 at mutually-spaced locations, such that the housing 72 serves as a bridge extending between the horizontally-spaced cables 14.

The cables 14 enter the housing 72 via respective openings or passageways 76 in a lower wall of the housing 72. Each cable 14 is received in a respective tube 48 that is sealed in watertight fashion to the housing 72 in alignment with a respective one of the passageways 76. Each tube 48 extends downwardly from the housing 72 and consists of or comprise a downwardly-tapering bend stiffener 56 surrounding the respective cable 14 hanging from the housing 72.

To connect and disconnect the cables 14 to or from each other via the junction box 74, the junction box 74 is accessible via an access opening 78 in a wall of the housing 72, that opening 78 being closable in a watertight manner by a movable or removable closure 80. In this example, the closure 80 is a hinged hatch that closes an access opening 78 in an upper wall of the housing 72 above the junction box 74. The closure 80 is shown open in FIG. 12a and closed in FIG. 12b.

In this example, the closure 80 includes a cable port 82 for connecting the junction box 74 within the housing 72 to a junction box 44 of the wind turbine 12 via an intermediate cable 40 as shown in FIG. 13b. The cable port 82 could be positioned elsewhere in a wall of the housing 72. Similarly, the intermediate cable 40 could instead connect to the junction box 74 in the housing 72 via a connector provided in the closure 80 or elsewhere in a wall of the housing 72.

When the access opening 78 is closed by the closure 80, the connection 38 can float at the surface 22 of a body of water as shown in FIG. 12b. Positive buoyancy conferred on the connection 38 by air trapped within the housing 72 may be sufficient to keep the housing 72 at the surface 22 but supplementary external buoyancy 84 can be attached to the housing 72 if required for that purpose.

On its upper side, the housing 72 further comprises lifting formations, exemplified here by padeyes 52, that facilitate lifting the connection 38 to and from a floating wind turbine 12 with the cables 14 suspended beneath. Conversely, on the lower side of the housing 72, provision is made for mechanical connection to the wind turbine 12. In this example, that provision comprises horizontally-extending flanges 86 sandwiched between the respective tubes 48 and the housing 72, or surrounding each tube 48, such that the cables 14 extend through the flanges 86.

FIG. 13a shows the connection 38 being lifted on wires 88 coupled to the padeyes 56 and being aligned with supports 46 on the wind turbine 12. When the housing 72 is then lowered onto the supports as shown in FIG. 13b, the flanges 86 rest on the supports 46 to effect mechanical connection between the connection 38 and the wind turbine 12. An electrical connection can then be made between the junction box 74 within the housing 72 and the junction box 44 of the wind turbine 12, in this example via the intermediate cable 40 extending through the cable port 82 as shown in FIG. 13b.

The hollow housing 72 of the connection 38 may have various shapes. For example, FIGS. 14 to 16 show a housing 72 with an arched or crescent shape that is bent along its length, defining downwardly-extending horns or legs that align with the respective cables 14, tubes 48, bend stiffeners 56 and flanges 86. The access opening 78 and closure 80 of the preceding embodiment shown in FIGS. 12a to 13b have been omitted from these schematic views but could be located at any position on the housing 72 that affords access to the junction box 74 within. Similarly, the external buoyancy 84 of the preceding embodiment has been omitted from FIGS. 14 to 16 but could be provided on the housing 72.

In FIG. 14, the tubes 48 are parallel I-tubes from which bend stiffeners 56 extend downwardly in parallel relation, axially aligned with the downwardly-facing legs of the curved housing 72. Conversely, the tubes 48 in FIGS. 15 and 16 are J-tubes such that bend stiffeners 56 extending from them are inclined to the vertical. In FIG. 15, the J-tubes 48 have mutually opposed inclination such that the associated bend stiffeners 56 and cables 14 splay apart downwardly with mutually opposed inclination to the vertical. In FIG. 16 the J-tubes 48 have matching inclination such that the associated bend stiffeners 56 and cables 14 are substantially parallel to each other with corresponding inclination to the vertical. Similar arrangements of I-tubes or J-tubes may be applied to the preceding embodiment.

FIG. 17 shows an anchoring arrangement in which the positive buoyancy of the connection 38 shown in FIGS. 14 to 16 applies tension to a taut anchor line 28 that lies between the cables 14 and extends from the housing 72 to a subsea foundation 64. The connection 38 is shown here held at the surface 22 but could instead be held beneath the surface 22. In this example, the foundation 64 is a clump weight or dead-man anchor resting on the seabed 26 and the cables 14 hang from the connection 38 in opposed wave configurations that include hogbends supported by buoyancy units 66. In other examples, the cables 14 could extend from the connection 38 to the seabed 26 in a conventional catenary configuration as shown on the right in FIG. 10. Similar anchoring arrangements could be applied to the preceding embodiment of the connection 38 shown in FIGS. 12a to 13b. Conversely, different mooring arrangements could be applied to the embodiment shown in FIG. 17, such as three or more catenary moorings.

Turning finally to FIGS. 18 and 19, these drawings show that a connection 38 of the invention can connect three or more cables 14 into one or more junction boxes 74 within a floating watertight housing 72. The cables 14 extend downwardly from the housing 72 through respective passageways 76 in a lower wall of the housing 72, those passageways 76 being aligned with respective downwardly-extending tubes 48 that may comprise or consist of bend stiffeners 56 as shown. FIG. 18 also shows that the cables 14 can also extend through flanges 86 for mechanical connection to the wind turbine 12.

In this example, three cables 14 are supported together in a triangular arrangement in plan view, preferably an equilateral triangular arrangement. The housing 72 therefore has a generally triangular star shape in plan view, comprising three arms 90 that extend outwardly with equiangular spacing from an enlarged central hub 92 to support the respective cables 14 in tubes 48 near the outer ends of the arms 90. The central longitudinal axis of each arm 90 lies at 120° to the axes of its neighbouring arms 90.

FIG. 18 shows that the junction box 74 is disposed centrally within the hub 92 where the longitudinal axes of the arms 90 intersect. FIG. 19 shows how the junction box 74 can be accessed through an access opening 78 in the top of the housing 72, that opening 78 being closable by a watertight closure 80.

FIG. 19 also shows an anchoring and cable arrangement akin to that of FIG. 17. Thus, the positive buoyancy of the connection 38 applies tension to a taut anchor line 28 that lies between the cables 14 and extends from the housing 72 to a subsea foundation 64. Again, the connection 38 is shown here held at the surface 22 but could instead be held beneath the surface 22. Similarly, the foundation 64 is a dead-man anchor resting on the seabed 26 and the cables 14 hang from the connection 38 in a wave configuration including hogbends supported by buoyancy units 66. Other variants could have other anchoring or mooring arrangements or a different cable arrangement such as a conventional catenary configuration.

The anchoring arrangements shown in FIGS. 17 and 19 could be permanent or temporary. In this context, ‘permanent’ means that the connection 38 is designed to be left floating in water continuously as part of normal operation of an offshore wind turbine installation. Conversely, ‘temporary’ means that the connection 38 is placed in water only briefly as an interim measure while constructing, developing or maintaining the installation.

Many other variations are possible within the inventive concept. For example, other known buoyant base arrangements such as spar buoys or barges are possible. Similarly, other known mooring or tethering arrangements for floating units are possible, such as tension legs. It would also be possible for any or all of the turbines and/or the hub or other offshore units to stand on foundations on the seabed, for example via a jacket or other base structure.

Other possible variations are, for example, adaptation of the same inventive concept for a group or assembly of several cables, or of electrical cables and other functional lines such as fibre optic cables. Fibre optic cables can be connected via a splice box or a connection joint.

In variants of the embodiments that employ a junction box, one or more other electrical connectors could be employed to connect the cables instead.

1. A floating cable connection, comprising:
two or more substantially parallel elongate tubes each comprising an internal passageway for accommodating a respective cable;
at least one buoyant element fixed to the tubes; and
support formations fixed relative to the or each buoyant element, arranged to hold the tubes in an upright orientation on a supporting structure.

2. The connection of claim 1, wherein the buoyant element comprises a hollow housing containing at least one electrical connector within a watertight internal compartment, the or each connector electrically connecting upper ends of the cables to each other.

3. The connection of claim 2, wherein at least one junction box within the internal compartment serves as the at least one electrical connector.

4. The connection of claim 2, wherein the buoyant element further comprises buoyancy mounted externally to the housing.

5. The connection of claim 2, comprising an access opening in a wall of the housing communicating with the internal compartment to provide access to the at least one electrical connector, and a closure for closing the access opening.

6. The connection of claim 5, wherein the access opening is in an upper wall of the housing.

7. The connection of claim 2, wherein the passageways of the tubes communicate with the internal compartment.

8. The connection of claim 2, wherein the housing is cylindrical or crescent-shaped.

9. The connection of claim 8, wherein when the housing is crescent-shaped, downwardly-extending legs of the crescent shape communicate with each passageway of the tubes.

10. The connection of claim 2, further comprising at least one anchor line or mooring line each extending from the housing to a subsea foundation.

11. The connection of claim 10, wherein the anchor line or mooring line is coupled to the housing at a location between the tubes.

12. The connection of claim 1, wherein cables hang from the respective tubes to the seabed in catenary or wave configurations.

13. The connection of claim 1, wherein the support formations comprise at least one support protruding laterally from each tube.

14. The connection of claim 13, wherein the or each support is a flange that lies in a plane intersected by the or each tube.

15. The connection of claim 1, wherein the tubes are mutually spaced along their length and the or each buoyant element bridges a horizontal gap between the tubes.

16. The connection of claim 1, wherein at least one of the tubes has a lower end portion that is inclined relative to a longitudinal axis of an upper end portion of that tube.

17. The connection of claim 1, wherein lower end portions of the tubes are downwardly divergent from each other.

18. The connection of claim 1, wherein each tube is or comprises a bend stiffener.

19. The connection of claim 18, wherein a bend stiffener extends from a lower end of each tube.

20. The connection of claim 19, wherein at least one of the bend stiffeners is inclined relative to a longitudinal axis of the tube.

21. The connection of claim 20, wherein the bend stiffeners are downwardly divergent from each other.

22. The connection of claim 19, wherein the bend stiffener extends longitudinally in coaxial alignment with a longitudinal axis of the tube.

23. The connection of claim 1, comprising three of the substantially parallel elongate tubes all fixed to a common buoyant element, the tubes being in a triangular array in plan view.

24. An offshore structure in combination with at least one connection of claim 1.

25. The structure of claim 24, comprising support formations that are complementary to the support formations of the or each connection.

26. The structure of claim 25, whose support formations are arranged for hang-off engagement with the support formations of the or each connection.

27. The structure of claim 24, wherein the connection is electrically connected to the structure.

28. The structure of claim 27 wherein:
the buoyant element comprises a hollow housing containing at least one electrical connector within a watertight internal compartment, the or each connector electrically connecting upper ends of the cables to each other:
the connection comprises an access opening in a wall of the housing communicating with the internal compartment to provide access to the at least one electrical connector, and a closure for closing the access opening; and
the connection is electrically connected to the structure through the access opening.

29. A method of disconnecting at least two cables from an offshore structure, the method comprising:
holding upper end portions of the cables within respective upright elongate tubes fixed relative to each other and removably supported by the structure;
disconnecting upper ends of the cables from an electrical system of the structure;
electrically connecting the upper ends of the cables to each other;
detaching the tubes containing the upper end portion of the cables from the structure;
transferring the tubes containing the upper end portions of the cables into water beside the structure; and
supporting the tubes and the upper end portions of the cables in the water by virtue of at least one buoyant element fixed to the tubes.

30. The method of claim 29, comprising electrically connecting the upper ends of the cables to each other within an internal watertight compartment of the buoyant element.

31. The method of claim 30, comprising opening an access opening in a wall of the buoyant element, accessing the compartment through the access opening, electrically connecting the upper ends of the cables to each other, and closing the access opening.
